(19) United States
(12) Patent Application Publication
(10) Pub. No.: US 2005/0283828 A1
(43) Pub. Date: Dec. 22, 2005

(54) Multipurpose media access data processing system

(76) Inventors: Tim E. Perley, Boulder, CO (US); Michael J. Stember, Longmont, CO (US); Jeff Lavin, Longmont, CO (US); David C. Wahl, Longmont, CO (US)

Correspondence Address: HAMILTON & TERRILE, LLP, P.O. BOX 203518, AUSTIN, TX, 78720, US

(21) Appl. No.: 10/897,135

(22) Filed: Jul. 22, 2004

Related U.S. Application Data
(60) Provisional application No. 60/580,297, filed on Jun. 16, 2004.

(51) Int. Cl. H04K 1/00; H04L 9/00; H04L 9/32; G06F 12/14; G06F 11/30

(52) U.S. Cl. 726/4; 713/185

(57) ABSTRACT

A multipurpose media access device, which includes a communication interface operable to control transfer of data between said multipurpose user device and at least one communication network, a data storage module operable to store user data and a unique user identifier, a program storage module having at least one executable program stored therein, wherein said program contains instructions to use said unique user identifier to enable a predetermined set of operational features for said multipurpose media access device to enable a limited set of data transfer capabilities on said communication network in accordance with a user profile associated with said unique user identifier, a processor operable to execute said executable program stored in said program storage module to process data stored in said data storage module to generate a set of user data, and a display for displaying said processed user data.

### CROSS-REFERENCE TO RELATED APPLICATION

This application claims the benefit under 35 U.S.C. § 119(e) of U.S. Provisional Application Ser. No. 60/580,297, filed Jun. 14, 2004, entitled “Multi-Purpose Media Access Data Processing System.”

### BACKGROUND OF THE INVENTION

1. Field of the Invention

The present invention relates to the field of information handling systems and more particularly to a multipurpose media access data processing system.

2. Description of the Related Art

Computer systems have attained widespread use for providing computer power to many segments of today's modern society. A personal computer system can usually be defined as a microcomputer that includes a system unit having a system processor and associated volatile and non-volatile memory, a display monitor, a keyboard, one or more diskette drives, a fixed disk storage device and an optional printer. These personal computer systems are information handling systems which are designed primarily to give independent computing power to a single user (or a group of users in the case of personal computers which serve as computer server systems) and are inexpensively priced for purchase by individuals or small businesses.

Known computer systems include various hardware components. In addition, when a user receives a computer system, the computer system may be pre-loaded with certain software applications, such as a word processor, an e-mail program or a browser application to enable browsing of the Internet.

One component of the Internet is the World Wide Web (“the Web”), which is a globally connected network that includes multiple Web “pages.” Web pages are collections of information that can be viewed by a user through the use of browser software. Browser software is sometimes referred to herein as “a browser.” A browser is a special-purpose software application program that performs the requesting and displaying of Web pages through a communications link.

A Web page can incorporate various multimedia components including text, graphics, sounds, including music and speech, animation, and video images. Web pages that include sound components can be heard as well as seen using a browser. Web pages are interconnected to one another using hypertext that allows a user to move from any Web page to another Web page, and to graphics, binary files, multimedia files, as well as any Internet resource.

The Web operates on a client/server model. The Web allows a server computer system to send graphical Web pages of information to a remote client computer system. A server computer system (“server system”) includes a hardware server as well as software Web pages that make up a Web “site” as described below. The terms for the hardware “server” and the “site” are sometimes used interchangeably.

The remote client computer system can display Web pages because it includes a browser. A user runs Web client browser software such as Netscape Navigator™ or Microsoft's Internet Explorer™ on the user's computer. The browser software acts as a client that contacts a Web server and requests information or resources. The Web server locates and then sends the information to the Web browser, which displays the results to the user on the user's computer.

Web pages are defined using a markup language called Hypertext Markup Language (“HTML”). HTML provides a standard set of tags that define how a Web page is to be displayed. HTML contains commands that are sent from the server to tell the browser on the remote client computer how to display text, graphics and multimedia files. It also contains commands for linking the Web page to other Web pages and to other Internet resources.

It is desirable to provide a device having computer system functionality to a larger segment of the world's population than can now afford computer systems.

### SUMMARY OF THE INVENTION

The system of the present invention includes a unique ID that is leveraged to prevent unauthorized copying or reuse of the system image and applications due to duplication of the hard drive. The unique ID is accessible to applications in the operating system image. This access may be in the form of an encrypted ID at the operating system level to prevent duplication of the ID on unauthorized systems to gain access to the internet service provider. One implementation provides an encryption key for the unique ID as a public key that is downloaded by the internet service provider and implemented in such a fashion that it can be periodically updated by the internet service provider. When a system is provided to a customer, this unique ID is registered to the customer to allow access to the internet and e-mail accounts. The internet service provider can use the unique ID to prevent access to the internet or e-mail server by disabling service to the specified account (UUID).

In one embodiment, the invention relates to a multipurpose media access device, which includes a communication interface operable to control transfer of data between said multipurpose user device and at least one communication network, a data storage module operable to store user data and a unique user identifier, a program storage module having at least one executable program stored therein, wherein said program contains instructions to use said unique user identifier to enable a predetermined set of operational features for said multipurpose media access device to enable a limited set of data transfer capabilities on said communication network in accordance with a user profile associated with said unique user identifier, a processor operable to execute said executable program stored in said program storage module to process data stored in said data storage module to generate a set of user data, and a display for displaying said processed user data.

The present invention provides a low cost multipurpose, internet-connectable computing device. The system provides a fixed and limited subset of personal computer computing capabilities that are linked to a unique user identifier. The system of the present invention can support both Windows-based and Linux-based Operating Systems. In one embodiment of the invention, the operating system is based on a mobile version of Windows such as Windows CE. In the present invention, the operating system is preconfigured with a factory installed image and cannot be altered by the user. Preconfigured software applications include a word processor, a spreadsheet, a web browser, a PDF viewer, media player and drawing applications. The system of the present invention does not include applications that are specific to any one market. Rather, internet links are defined and pre-configured on the desktop to allow the user to use Web-based e-mail, on-line gaming, and entertainment including music, movie and sports links, local news and weather and a popular search engine. The desktop that is presented on the display device is pre-configured to include these Web links as part of the operating system load.

In the present invention, backup of user data may be provided via an internet service provider. In one embodiment of the present invention, user data is stored on a recovery image stored in disk partition that is separate from the disk partition containing the system data. The recovery image allows the user or a service person to update or repair operating system images in the field at limited expense.

In another embodiment, the invention relates to a method of controlling a multipurpose media access device for operation in conjunction with a data communication network which includes storing a unique user identifier in a storage module in said multipurpose media access device, wherein said unique user identifier corresponds to a predetermined set of operational features for said multipurpose media access device to enable a limited set of data transfer capabilities on said communication network in accordance with a user profile associated with said unique user identifier, and executing a program stored in a program storage module of said multipurpose media access device, wherein said program contains instructions to use said unique user identifier to enable said predetermined set of operational features to provide limited transfer of data between said multipurpose media access device and said communication network in accordance with the user profile associated with said unique user identifier.

The present invention provides an environment for managing accounts between an internet service provider, such as a telephone company, and a plurality of low cost multipurpose, internet-connectable computing devices. The environment uses a unique ID that is associated with every computing device to validate whether the device should have access to the internet. The environment enables an internet service provider to make the determination of whether a device is a valid system based upon a plurality of criteria including whether payment for the multipurpose media access device is up to date, whether the device has been reported stolen, whether there are duplicate copies of the same device (thus indicating that unapproved copies of software have been made), whether the location from which the device is establishing the connection corresponds to an expected location. Thus, the internet service provider can use this determination to manage the business portion of the relationship with the user.

In another embodiment, the invention relates to an environment for managing accounts between a service provider and a multipurpose media access device, which includes a multipurpose media access device coupled to a communication medium. The multipurpose media access device includes an associated unique identifier and a service provider coupled to the communication medium. The service provider includes a verification module. The verification module determines, when the multipurpose media access device desires access to a service provided by the service provider, that the multipurpose media access device is a valid system.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a block diagram of a system for providing a low cost multipurpose media access device to a plurality of users.

FIG. 2 shows a system block diagram of a multipurpose media access device.

FIG. 3 shows a block diagram of a processor system for use in the multipurpose media access device.

FIG. 4 shows a block diagram of an input output (I/O) system for use in the multipurpose media access device.

FIG. 5 shows a block diagram of the power states of the multipurpose media access device.

FIG. 6 shows a block diagram of the software of the multipurpose media access device.

FIG. 7 shows a block diagram of the system recovery of the multipurpose media access device.

FIG. 8 shows a flow chart of the operation of account management of the system for providing a low cost multipurpose media access device to a plurality of users.

### DETAILED DESCRIPTION

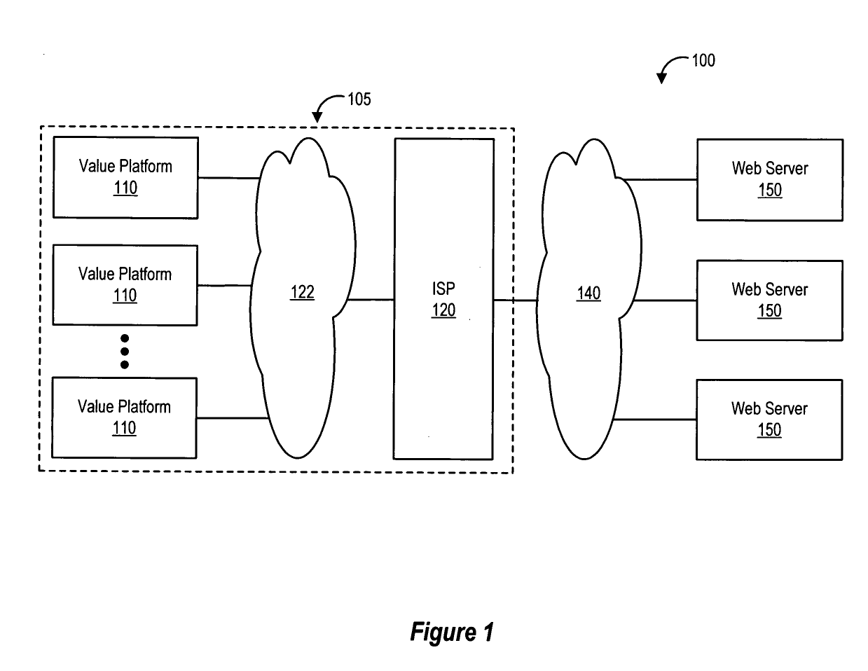

Referring to FIG. 1, a block diagram of an environment 100 for providing a low cost computing multipurpose media access device to a plurality of users is shown. More specifically, a plurality of multipurpose media access devices 110 are coupled to an internet service provider 120 via a communication link 122 such as a telephone line. The combination of one or more multipurpose media access devices 110 and the internet service provider 120 provides a system for providing a low cost computing multipurpose media access device to a plurality of users. The internet service provider 120 is then coupled to the Internet 140. The Internet 140 is then coupled to a plurality of Web host servers 150.

A user that wishes to access information on the Internet uses the multipurpose media access device 110, also referred to as “the client workstation.” The multipurpose media access device 110 executes an application program known as a Web browser.

The multipurpose media access device 110 includes communication hardware and software that allows the multipurpose media access device 110 to send and receive communications to and from the internet service provider 120. The communications hardware and software allows the multipurpose media access device 110 to establish a communication link with the internet service provider 120. The communication link may be any of a variety of connection types including a wired connection, a direct link such as a digital subscriber line (DSL), T1, integrated services digital network (ISDN) or cable connection, a wireless connection via a cellular or satellite network or a local data transport system such as Ethernet or token ring over a local area network.

When the customer enters a request for information by entering commands in the Web browser, the multipurpose media access device 110 sends a request for information, such as a search for documents pertaining to a specified topic, or a specific Web page to the internet service provider 120 which in turn forwards the request to an appropriate Web host server 150 via the Internet 140.

The Internet service provider 120 executes software for receiving and reading requests sent from the browser. The Internet service provider 120 executes a Web server application program that monitors requests, services requests for the information on that particular Web server, and transmits the information to the user's multipurpose media access device 110.

Each Web host server 150 on the Internet has a known address that the user supplies to the Web browser to connect to the appropriate Web host server 150. If the information is not available on the user's Web host server 150, the Internet 140 serves as a central link that allows Web servers 150 to communicate with one another to supply the requested information. Because Web servers 150 can contain more than one Web page, the user will also specify in the address which particular Web page he wants to view. The address, also known as a universal resource locator (URL), of a home page on a server is a series of numbers that indicate the server and the location of the page on the server, analogous to a post office address. For simplicity, a domain name system was developed that allows users to specify servers and documents using names instead of numbers. A URL may further specify a particular page in a group of pages belonging to a content provider by including additional information at the end of a domain name.

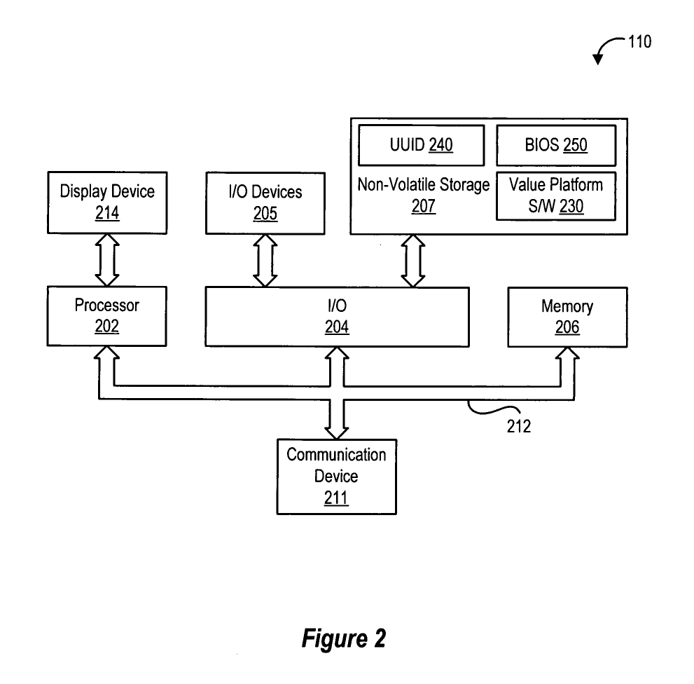

Referring to FIG. 2, a block diagram of multipurpose media access device 110 is shown. The multipurpose media access device 110 includes a processor 202, input/output (I/O) control device 204 which is coupled to I/O devices 205 such as a keyboard, a mouse, etc. and memory 206 including volatile memory such as random access memory (RAM). The I/O control device 204 is also coupled to non-volatile storage 207 such as a hard disk and drive. The multipurpose media access device 110 also includes a communication device 211 such as a modem. The processor 202, I/O controller 204, memory 206 and communication device 211 are interconnected via one or more buses 212. The processor 202 is also configured to be coupled to a display device 214. The non-volatile storage 207 includes multipurpose media access device software 230 as well as a unique user identifier (UUID) 240. The multipurpose media access device software 230 is executed on the processor 202. The unique user identifier 240 may be stored for example on a read only memory device (ROM) or on a hardwired integrated circuit.

In one embodiment, the multipurpose media access device 110 incorporates the AMD Geode GX2 processor operating at 366 MHz with the DDR memory and CRT output.

Also, in one embodiment, the memory 206 includes 128 Mbytes of 266 MHz DDRAM. The DDRAM is supported by either an on board configuration with foot print compatibility to support, e.g., between 64 and 2 5-12 MB with load options, or through a DIMM/SODIMM configuration. Implementation of the memory 206 is based on the best cost/flexibility tradeoff assessment. The memory is not intended to be accessible by the end user for upgrade but may be increased at time of manufacture based on the OEM requirements. In either case, to reduce cost and power consumption, the memory interface is un-terminated.

The non-volatile storage 207 of the multipurpose media access device 110 includes a boot ROM device to store and boot from the BIOS 250. This ROM device is field updateable through both a software and hardware mechanism. The software mechanism to update the BIOS 250 is a part of a system software update process and is invisible to the user. The hardware mechanism to update the BIOS 250 in the ROM is end user accessible.

The non volatile storage 207 of the multipurpose media access device 110 includes an integrated 3.5 inch hard disk drive with a minimum capacity of, e.g., 10 GB. The hard disk drive is not accessible by the user for replacement or upgrade. The hard drive supports UDMA 66 (mode 5) signaling at 3.3V to eliminate the need for voltage translation.

The communication device 211 of the multipurpose media access device 110 includes, for example, an integrated 56K ITU v. 92 Modem with an external connector on the multipurpose media access device 110. The modem supports phone systems in a variety of regions throughout the world. It will be appreciated that the modem may be a soft modem.

The multipurpose media access device 110 includes a means for implementing a unique user ID (UUID). The UUID is implemented such that the UUID cannot be easily changed or lost due to a system repair or upgrade.

The multipurpose media access device 110 includes integrated stereo headphone and microphone jacks capable of supporting stereo audio playback or full duplex audio for applications like voice over IP. The headphone jack is capable of driving headphones directly or connecting to powered external speakers. A line input jack is also provided. The audio connectors are labeled with graphical symbols not requiring translation.

The multipurpose media access device 110 includes four (4) USB connectors. All of the USB ports are capable of connecting to high power USB devices. The USB ports are labeled with a graphical symbol not requiring translation. Since the USB connectors on the front of the system are intended to support a mouse and a keyboard, these parts are labeled with universally recognized graphical symbols not requiring translation for a mouse and a keyboard. Since the USB connectors on the back of the system are intended to support a printer and specified optional devices, these parts are labeled with universally recognized graphical symbols for a printer and a USB connection not requiring translation.

The multipurpose media access device 110 provides a VGA connector on the rear panel supporting an external CRT with resolution up to SXGA, 24 bits color and 85 HZ refresh. The standard aspect ration of 4:3 is supported. The VGA connector is labeled with a graphical symbol not requiring translation.

To connect to the phone system, one RJ-11 connector is provided on the back panel. The multipurpose media access device 110 does not provide for a pass through connector. The modem port connector is labeled with a graphical symbol for a modem not requiring translation.

The multipurpose media access device 110 includes multiple mechanisms for placing the multipurpose media access device 110 into an image recovery mode. One such method is by pressing a button. This button is a hidden button that a user would not normally know is there and which is impossible to accidentally press. An example of this is a button that requires a paper clip or similar small object to be pushed into a hole on the enclosure to activate the button.

The multipurpose media access device 110 includes an external AC/DC adapter in conjunction with on board regulators capable of providing sufficient current and power to provide all required voltages to the system. Since the same power supply may be used in a variety of countries, the input supports 100-240VAC at 50-60 Hz.

USB connected flash storage devices are supported as the secondary means for moving files between the multipurpose media access device and other computers. The primary means for moving files is via e-mail. A source of low cost Flash Keys is made available as an accessory to the multipurpose media access device by the OEM. No unique driver is required for the Flash Keys.

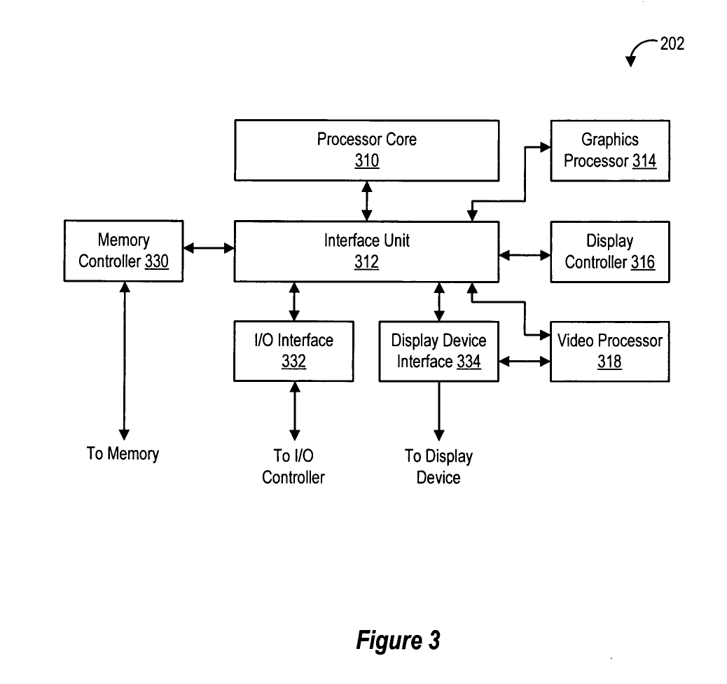

Referring to FIG. 3, a block diagram of the processor 202 is shown. In one embodiment, the processor 202 is a Geode GX2 processor available from Advanced Micro Devices. The processor 202 includes a processor core 310, an interface unit 312, a graphics processor 314, a display controller 316, and a video processor 318. The processor 202 also includes a memory controller 330, an I/O interface 332 and a display device interface 334. Additional aspects of the processor 202 are not shown in FIG. 3.

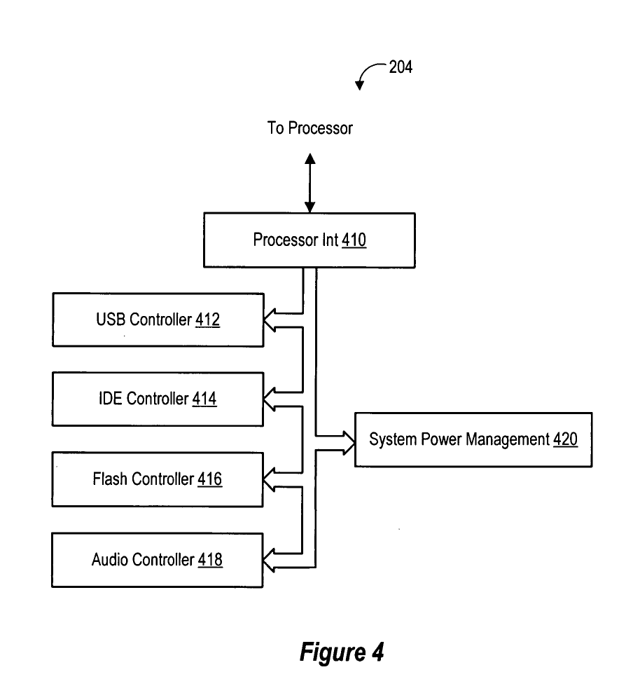

Referring to FIG. 4, a block diagram of the I/O control device 204 is shown. In one embodiment, the I/O control device is a Geode CS5535 I/O Companion Device available from Advanced Micro Devices. The I/O control device 204 includes a processor interface module 410, a USB controller module 412, an IDE controller module 414, a Flash memory controller module 416, an Audio controller module 418 and a system power management module 420.

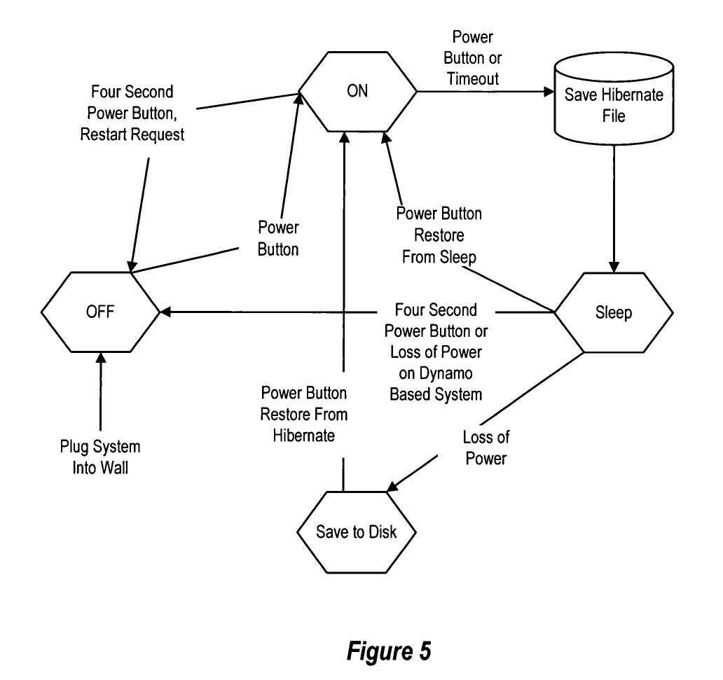

Referring to FIG. 5, a block diagram of the power states of the multipurpose media access device is shown. More specifically, the multipurpose media access device 110 includes a power button which provides control of the power state of the device. The power button is protected from accidental activation. The power button is labeled with a graphical symbol not requiring translation.

During the normal operation of the multipurpose media access device 110, the power button wakes the device from a hibernate, suspend or sleep state or places the device into one of these states. A four second actuation of the power button while in an on or sleep state forces the system into a hard off state.

While in the Sleep state, the LED is off, the display device is disabled, the hard disk is in the low power state and parked, and USB devices are disabled. This state appears identical to the powered off state to the user. Resume from sleep state occurs when the power button is actuated (less than 4 seconds) and released, and the resume time is faster than the monitor sync time.

The save to disk state is electrically identical to the off state. However, upon resume (power button is pressed), the BIOS 250 uses a hibernate file to resume the system rather than taking the standard boot path. Resume from the save to disk state takes less than ten seconds. The operating system supports the sleep state. Since boot time is less of an issue, it is not necessary to support the Save to Disk state. In the event of a power failure, the system will transition to off. While in the “on” state, system inactivity causes the system to go to sleep in the same manner as if the power button was momentarily pressed. The duration of the system inactivity is configured to 15 minutes by default. This timeout is user configurable within a multipurpose media access device system configuration.

The only states that apply to multipurpose media access device 110 are S0, S1, S3 (emulated) and S5. The user experience from the operating system allows for On (S0), Standby (S1 or S3) and Shutdown (S5).

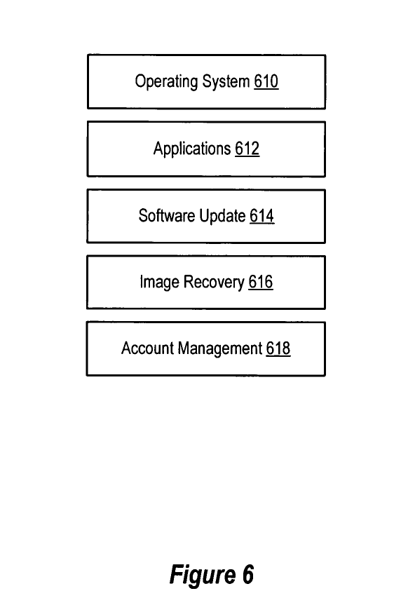

Referring to FIG. 6, the multipurpose media access device software 230 includes an operating system 610, an application program partition 612, a software update module 614, an image recovery module 616, and an account management module 618.

A personal computer compatible BIOS 250 is stored within the non-volatile storage 207, which can support both a Windows-based and Linux-based Operating Systems. The BIOS 250 may include a compatible bootloader to enable the operating system 610 to be an embedded closed operating system such as a Windows CE type operating system. The BIOS/Bootloader 250 is essentially invisible to the user and boots to the operating system.

More specifically, the Operating System 610 may be a Windows based operating system or a Linux based operating system. The Windows operating systems or Linux operating systems uniquely have several configurable operating parameters that can affect the performance of the system. These configurable operating parameters include animated menus, display window contents while dragging or pop-up balloons and will also include the boot configuration. Whether the operating system is Windows or Linux, all individual operating system characteristics are evaluated for their value versus performance impact on a system using the processor. These configuration settings are pre-configured in the installed image.

The multipurpose media access device 110 is shipped with all application programs 612 that are needed for the multipurpose media access device 110 to function as specified. The operating system 610 does not allow software to be installed by the user. The only way that applications are added or updated is via the multipurpose media access device software update module 614.

The multipurpose media access device 110 does not include applications that are specific to any one market. Rather internet links are defined and pre-configured on the desktop that target areas of interest that include Web based e-mail, on-line gaming, entertainment including music, movie and sports links, local news and weather and a popular search engine. The desktop that is presented on the display device 214 is pre-configured to include these Web links as part of the operating system load.

The multipurpose media access device 110 provides a limited and fixed subset of the personal computer functionality. The functionality that is included in the operating system is roughly equivalent to that of a personal computer version. The applications include word processor, spreadsheet, web browser, PDF viewer, media player and drawing applications.

Because closed operating system applications are often full screen only, switching between applications is not intuitive with the default user interface. Thus, the closed operating system includes an enhanced task bar.

The multipurpose media access device 110 does not include or support a CD-ROM drive, which would be the normal method for installing software and device driver packages. Software installation is disabled and managed instead via the internet service provider 120. As such, it is necessary to limit the use of USB peripherals to those supported in the image preload and generic class devices that do not require unique drivers or software. The primary intent for the multipurpose media access device 110 is to support mouse, keyboard, specified printers and flash storage devices (disk on key). Some internet service providers 120 may require support for USB network peripherals such as USB wireless, cable modem and DSL modem. The support for these devices is via pre-loaded drivers.

Product documentation makes this limitation clear; however, the system provides non-standard messaging to the user in the event that an attempt is made to attach a peripheral that does not have pre-loaded drivers. Boot from a USB device is disabled for the end user. However, the multipurpose media access device 110 includes a provision to allow service and support via USB.

The multipurpose media access device 110 system presents a look and feel that is unique. This look and feel includes the general graphical user interface (GUI), screen prompts and sounds. The software presents an appliance that provides personal computer-like functions but is not a personal computer. To further differentiate the multipurpose media access device 110 from a personal computer, the standard screens that are used for functions like booting, log in, suspend and resume are consistent with the look and feel of the branding for the multipurpose media access device system and specifically do not look like those of a personal computer.

Whether the multipurpose media access device 110 is in the process of a cold boot or returning from suspend to disk, the process happens quickly. The display does not display any text based screens. If the process requires more than one to two seconds to display a graphical screen, then a pseudo graphical screen is displayed to demonstrate that the multipurpose media access device 110 is in the process of booting. Once the system is capable of displaying a graphical screen, a display showing the Multipurpose media access device and OEM logos are displayed until the user login screen is displayed. While the system is booting, active graphical feedback is provided to the user to indicate that the system is starting up.

A log-in screen provides a simple graphical means of selecting a particular user account. After selecting the user account, the user enters their password.

For users new to PC operating systems, learning how to navigate and use the GUI can be a discouraging task. Since a primary objective of the multipurpose media access device 110 is to distinguish this product from a standard personal computer, a simplified user interface or shell option is available to the user. The simplified user interface is a configurable option and is the default user interface out of the box. This simplified user interface includes an easy to navigate method to launch the online and offline functionality, including a tutorial, web browsing, support or help, shortcuts to web sites of interest to users in the targeted country, and any other applications. The visual characteristics of this simplified interface creates a unified recognizable branding of the device but may also be customized for a specific targeted country and OEM to make the GUI appealing and easy to use based on the local culture.

The out of box experience for the multipurpose media access device 110 is substantially simpler than that of a personal computer. A novice user is able to set up and configure the system without any external assistance.

The first time the user boots the system there are several items that are configured. These include the user account, time and date, display configuration and dial up connection. These configurations are performed through an easy, intuitive and guided graphical interface. Setting the time and date is already done in this manner in Windows. The internet connection wizard can be leveraged on Windows. By default the system provides the look and feel of a single user account. A user can enable additional accounts. The default display configuration is defined as the ideal configuration for the monitor.

Since the system is targeted at novice users, the application program 612 includes basic training on operating system and application usage. These tutorials are openly visible to the user. This may be in the form of an icon on the desktop that begins a guided tour of the tutorials or a user prompt to run the tutorial the first time the application is run, or both.

The multipurpose media access device 110 may be used by various family members. Adults may have different privileges than juvenile users. Also, by having separate user accounts, each individual can set their own configuration preferences and have default access to their own documents folder. An Add New User option is available to the system's core account. The core account is the initial account on the system and is assumed to be the adult in the household. Adding a new user is a simple process of actuating an icon in the system configuration menu, setting the user name and password and selecting whether it is an adult or child account. If the account is a child account, then the internet parental controls can be set to restrict access to certain web pages.

With the closed operating system, separate desktop environments and separate default user file directories are provided to enable multiple user accounts.

The multipurpose media access device 110 enables software image maintenance for various scenarios, including operating system security patches, application patches, BIOS updates, new drivers and/or applications, etc.

A mechanism for patch management is included within the software. There is a minimum requirement for the internet service provider 120 to have patch capability. Operating system maintenance can be alternatively managed directly with the operating system vendor's infrastructure. For example, Windows can be maintained using the standard “Windows Update” service, but the internet service provider provides a mechanism to maintain the system.

The multipurpose media access device 110 includes productivity applications 612 like a word processor and spreadsheets, as well as the ability to browse the internet and save bookmarks, store pictures and save other data on the system. User configuration settings are stored on the system. All of the user's data should be stored in a location that a user has direct access to without the need to know how to navigate a file system. This user data is protected from the rest of the operating system to prevent corruption of the data by a virus or other means. In the event of a full system image recovery, the user data is persistent or overwritten unless a catastrophic hard disk hardware failure occurs.

In one embodiment, the user data is stored on a separate disk partition than the system data. A closed system based Multipurpose media access device supports a hard disk centric file management metaphor. Default storage is the hard disk drive, not memory. Also, applications 612 are aware of a user data file structure so the default location for saving and opening documents is from the user's document folder.

Backup of user data, other than the simple function or copying the user files from the disk to an external storage device may be provided via the internet service provider 120.

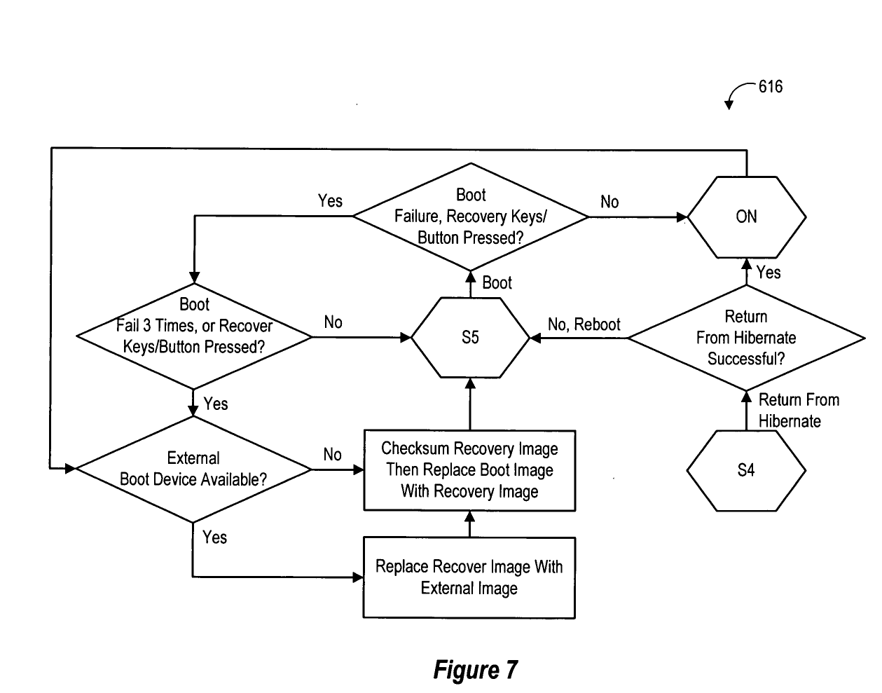

Referring to FIG. 7, flow chart of the operation of the image recovery module 616 is shown. The image recovery module 616 allows the user or a service person to update or repair operating system images in the field at limited expense. An example of an image recovery method is to boot from an update CD. However, because the multipurpose media access device 110 does not include a CD-ROM, a solution that recovers the image from a hidden (un-partitioned) portion of the disk is provided. The recovered image includes all updates and patches that the multipurpose media access device 110 has received. The user's data and configuration settings are persistent across a recovery. Prior to the image recovery, the user is prompted on whether they wish to continue with the recovery process and indicate how long it will take. While image recovery is occurring, the display device 214 provides feedback to the user that a recovery is occurring with an activity indicator to ensure that the system is not locked.

The multipurpose media access device 110 includes a unique ID and is leveraged to prevent unauthorized copying or reuse of the system image and applications due to duplication of the hard drive. The unique ID is accessible to applications in the operating system image. This access is in the form of an encrypted ID at the operating system level to prevent duplication of the ID on unauthorized systems to gain access to the internet service provider. One implementation provides an encryption key for the unique ID as a public key that is downloaded by the internet service provider and implemented in such a fashion that it can be periodically updated by the internet service provider. Upon connection to the internet service provider 120, the unique ID is decrypted by the internet server using the internet service provider's private key, to allow access to the internet or e-mail server.

When a system is provided to a customer, this unique ID is registered to the customer to allow access to the internet and e-mail accounts. If someone were to try an unauthorized system, the internet service provider 120 would prevent access to the internet or e-mail server by disabling service to the specified account (UUID). If someone were to use an unauthorized encrypted key to access the internet on a pirate system, this access will only be functional until the service provider updates the public key.

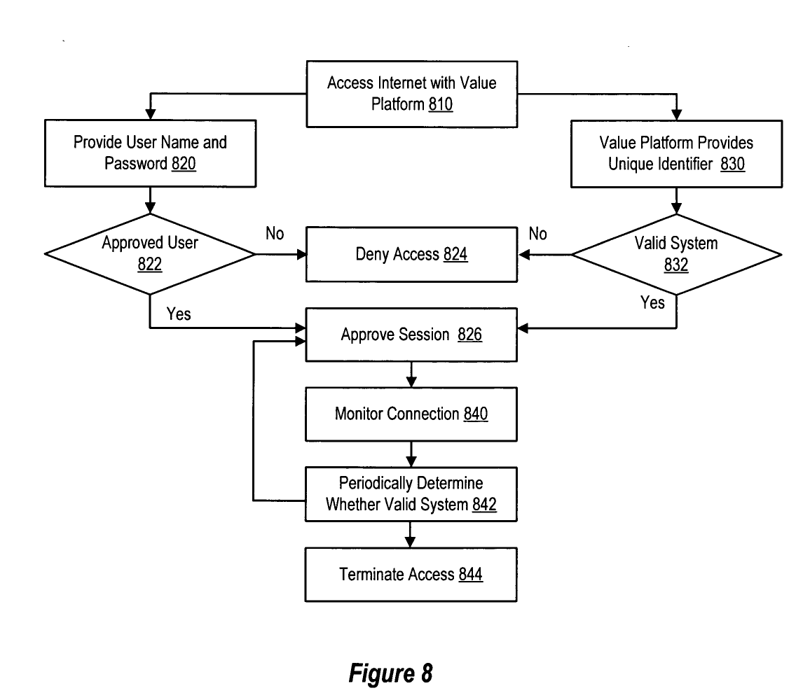

Referring to FIG. 8, a flow chart of the interaction of the account management module 618 and the internet service provider 120 to provide a low cost multipurpose media access device to a plurality of users is shown. More specifically, a user starts an internet session with the multipurpose media access device 110 by accessing the internet with the multipurpose media access device at step 810. A connection with the internet service provider 120 is established via the communication device. The user then provides a user name and a password to the internet service provider at step 820. The internet service provider 120 then determines whether the user is an approved user at step 822. If the user is not an approved user, then the internet service provider denies access to the internet at step 824. If the user is an approved user, then the internet service provider approves the session at step 826 and the user is connected to the Internet via the internet service provider 120.

Additionally, while the user is providing their user name, the multipurpose media access device 110 provides the UUID to the internet service provider 120 in the background, without user knowledge or intervention at step 830. The internet service provider then determines whether the multipurpose media access device is a valid system at step 832. The internet service provider 120 may determine whether the multipurpose media access device 110 is a valid system based upon a plurality of criteria including whether payment for the multipurpose media access device is up to date, whether the multipurpose media access device 110 has been reported stolen, whether there are duplicate copies of the same device (thus indicating that unapproved copies of software have been made), and whether the location from which the device is establishing the connection corresponds to an expected location. Essentially, the internet service provider 120 can use this determination to manage the business portion of the relationship with the user. For example, if the multipurpose media access device 110 was leased to a user, this determination can determine whether the terms of the lease are being followed. If the system is a valid system, then the user is connected to the Internet via the internet service provider at step 826.

The internet service provider 120 may then monitor the Internet session based upon certain criteria such as a length of time that the connection is in effect at step 840. Based upon the monitoring, the internet service provider 120 can periodically determine whether the connected multipurpose media access device 110 is a valid system at step 832. If the connected multipurpose media access device 110 is a valid system, then the internet service provider 110 continues to approve the session at step 826. If the connected multipurpose media access device 110 is not a valid system, then the internet service provider 120 terminates access to the internet at step 844.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, the above-discussed embodiments include modules that perform certain tasks. The modules discussed herein may include hardware modules or software modules. The hardware modules may be implemented within application specific circuitry or via some form of programmable logic device. The software modules may include script, batch, or other executable files. The modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Also for example, it will be appreciated that all the software discussed with reference to the multipurpose media access device can operate as a signal embedded in a carrier wave.

Also for example, it will be appreciated that other multipurpose media access device architectures are within the scope of the invention.

Consequently, the invention is intended to be limited only by the spirit and scope of the appended claims, giving full cognizance to equivalents in all respects.

1. A multipurpose media access device, comprising:
a communication interface operable to control transfer of data between said multipurpose access device and at least one communication network;
a data storage module operable to store user data and a unique user identifier;
a program storage module having at least one executable program stored therein, wherein said program contains instructions to use said unique user identifier to enable a predetermined set of operational features for said multipurpose media access device to enable a limited set of data transfer capabilities on said communication network in accordance with a user profile associated with said unique user identifier;
a data processor operable to execute said executable program stored in said program storage module to process data stored in said data storage module to generate a set of processed user data in accordance with said user profile; and
a display operable to display said processed user data.

2. The multipurpose multimedia device according to claim 1, wherein said unique user identifier is stored in said data storage module as an encrypted data file.

3. The multipurpose multimedia device according to claim 2, wherein said set of user data is generated using a public key provided by an internet service provider.

4. The multipurpose multimedia device according to claim 3, further comprising a pre-configured operating system stored in said data module, wherein said operating system cannot be altered by a user.

5. The multipurpose multimedia device according to claim 4, wherein said program storage module comprises a hidden partition and wherein a recovery version of said operating system is stored in said hidden partition.

6. The multipurpose multimedia device according to claim 5, wherein said operating system comprises a graphical user interface-based operating system.

7. The multipurpose multimedia device according to claim 6, wherein said operating system comprises an embedded closed operating system.

8. The multipurpose multimedia device according to claim 5, wherein said operating system comprises unix-based operating system.

9. The multipurpose multimedia device according to claim 5, wherein said user data stored in said data storage module is backed up via an internet service provider network connection.

10. The multipurpose multimedia device according to claim 6, wherein said limited set of data transfer capabilities comprises a plurality of predefined internet links.

11. A multipurpose media access device, comprising:
means for controlling transfer of data between said multipurpose access device and at least one communication network;
means for storing user data and a unique user identifier;
means for storing a program, having at least one executable program stored therein, wherein said program contains instructions to use said unique user identifier to enable a predetermined set of operational features for said multipurpose media access device to enable a limited set of data transfer capabilities on said communication network in accordance with a user profile associated with said unique user identifier;
data processing means for executing said executable program stored in said program storage module to process data stored in said data storage module to generate a set of processed user data in accordance with said user profile; and
means for displaying said processed user data.

12. The multipurpose multimedia device according to claim 11, wherein said unique user identifier is stored in said data storage module as an encrypted data file.

13. The multipurpose multimedia device according to claim 12, wherein said unique user identifier is stored in nonvolatile means for storing data.

14. The multipurpose multimedia device according to claim 13, further comprising pre-configured operating system stored in said means for storing a program, wherein said operating system cannot be altered by a user.

15. The multipurpose multimedia device according to claim 14, wherein said means for storing a program comprises a hidden partition and wherein a recovery version of said operating system is stored in said hidden partition.

16. The multipurpose multimedia device according to claim 15, wherein said operating system comprises a graphical user interface-based operating system.

17. The multipurpose multimedia device according to claim 16, wherein said operating system comprises an embedded closed operating system.

18. The multipurpose multimedia device according to claim 15, wherein said operating system comprises a unix-based operating system.

19. The multipurpose multimedia device according to claim 15, wherein said user data stored in said means for storing data is backed up via an internet service provider network connection.

20. The multipurpose multimedia device according to claim 16, wherein said limited set of data transfer capabilities comprises a plurality of predefined internet links.
